(19) United States
(12) Patent Application Publication
(10) Pub. No.: US 2007/0127166 A1
(43) Pub. Date: Jun. 7, 2007

(54) MAGNETIC DETECTING DEVICE HAVING TWO-LAYERED SEED

(75) Inventors: Kazumi Kamai, Niigata-ken (JP); Naoya Hasegawa, Niigata (JP); Eiji Umetsu, Niigata-ken (JP); Kazuaki Ikarashi, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/567,684

(22) Filed: Dec. 6, 2006

(30) Foreign Application Priority Data
Dec. 6, 2005 (JP) 2005-351776

(51) Int. Cl. G11B 5/127; G11B 5/33

(52) U.S. Cl. 360/324.1

(57) ABSTRACT

A magnetic detecting device is disclosed having a fixed magnetic layer, a free magnetic layer, and a nonmagnetic material layer between the fixed magnetic layer and the free magnetic layer. A laminated seed layer having NiFeCr is proximate the fixed magnetic layer. In one version, an antiferromagnetic layer is between the fixed magnetic layer and the laminated seed layer

### CROSS-REFERENCE TO RELATED APPLICATION

This application claims the benefit of Japanese Patent Application 2005-351776, filed Dec. 6, 2005, which is hereby incorporated herein by reference.

### FIELD OF THE DISCLOSURE

The present disclosure relates to magnetic detecting devices. More particularly, the disclosure relates to magnetic detecting devices having seed layers that exhibit magneto-resistance effects.

### BACKGROUND

Magnetic detecting devices have seed layers to increase the change in electrical resistance that occurs in response to reading a data bit from a hard disk. However, seed layers are usually kept thin to restrain shunt loss and avoid output reduction. A thin seed layer also narrows the gap between the shied layers provided on and under the spin valve thin film element, which improves line recording density. However, a thin seed layer may provide a low rate of change in resistance (ΔR/R), diminishing the desired seed effect. In JP-A-2005-203572, JP-A-2003-174217, JP-A-2002-299726, and JP-A-2002-232035, a spin valve thin film element in which a seed layer formed of NiFeCr is provided under a magnetoresistance effect part including an antiferromagnetic layer, a fixed magnetic layer, nonmagnetic material layer, and a free magnetic layer is disclosed.

In column [0042] of JP-A-2005-203572, “The seed layer 33 preferably has a monolayer structure of the magnetic material layer or the nonmagnetic material layer in which the (111) plane of a face-centered cubic structure or the (110) plane of a body-centered cubic structure is most preferentially oriented. For this reason, in the crystalline orientation of the antiferromagnetic layer 34, the (111) plane can be most preferentially oriented, and hence the rate of change in resistance of the magnetic detecting device can be improved” is disclosed.

However, if the thickness of the seed layer formed of NiFeCr is very thin, it has been known that the seed effect is not approximately exhibited. For example, in column [0104] of JP-A-2003-174217, it is disclosed that the seed layer is formed in 60 \acute{Å}.

However, in order to more increase the output of a head, it is preferable that the seed layer be formed so as to have the thin thickness, thus restraining diversion shunt loss of current flowing to the seed layer. In addition, if the seed layer is thinly formed, it may narrow the gap between shied layers provided on and under the spin valve thin film element and can improve a line recording density.

In column [0071] of JP-A-2002-232035, the laminated structure of “Ta 3 nm/NiFeCr 2 nm/CoFe 1.5 nm/NiFeCr 1 nm/PtMn 10 nm . . . ” is described. “The NiFeCr layer of 20 \acute{Å} (2 nm) formed on the Ta layer is the seed layer” is disclosed in column [0074] of JP-A-2002-232035. In JP-A-2002-232035 as compared with JP-A-2003-174217, the thickness of the seed layer formed of NiFeCr is getting thinner. However, in experiments described below, if the thickness of the seed layer formed of NiFeCr is thinly formed, the rate (ΔR/R) of change in resistance is largely reduced, and no seed effect is exhibited. In addition, in JP-A-2002-232035, a CoFe layer of 15 \acute{Å} (1.5 nm) is formed on the NiFeCr layer serving as the seed layer, and the NiFeCr layer of 10 \acute{Å} (1 nm) is formed on the CoFe layer. In column [0032] of JP-A-2002-232035, the CoFe layer is described as BCL, which compensates an external magnetic field (bias) caught in the free magnetic layer. Furthermore, in column [0079] of JP-A-2002-232035, the NiFeCr layer formed on the CoFe layer is described as a decoupling layer for cutting a magnetic coupling between BCL having a magnetic property and the antiferromagnetic layer. Even though it is uncertain whether the BCL and the decoupling layer function as the seed layer or not, the effective seed effect is not exhibited by the laminated structure of NiFeCr/CoFe/NiFeCr and the thickness of the layer described in JP-A-2002-232035. In addition, the composition ratio of CoFe is also not disclosed.

### SUMMARY

The present invention is defined by the claims and nothing in this section should be taken as a limitation on those claims.

One version of the magnetic detecting device of the present disclosure has a fixed magnetic layer, a free magnetic layer, and a nonmagnetic material layer between the fixed magnetic layer and the free magnetic layer. A laminated seed layer having NiFeCr is proximate the fixed magnetic layer. In one version, an antiferromagnetic layer is between the fixed magnetic layer and the laminated seed layer.

The preferred embodiments will now be described with reference to the attached drawings.

### BRIEF DESCRIPTION OF THE DRAWINGS

FIG. 1 is a cross sectional view (parallel to the surface of a recording medium) of a version of a thin film magnetic head of the present invention;

FIG. 2 is a partially enlarged pattern diagram of a portion of FIG. 1 showing the concentration of Co contained in a seed layer;

FIG. 3 is a graph showing the relationship between the thickness of a seed layer formed with NiFeCr and Co layers, and the thickness of a seed layer having a single-layer structure of NiFeCr and a minimum resistance value;

FIG. 4 is a graph showing the relationship between the thickness of a seed layer formed with NiFeCr and Co layers, and a thickness of the seed layer having a single-layer structure of NiFeCr and a rate (ΔR/R) of change in resistance;

FIG. 5 is a graph showing an enlarged portion of the graph of FIG. 4;

FIG. 6 is a graph showing the relationship between the thickness of the seed layer formed with NiFeCr and CoFe layers, and the thickness of the seed layer having a single-layer structure of NiFeCr and a minimum resistance value;

FIG. 7 is a graph showing the relationship between the thickness of the seed layer formed with NiFeCr and CoFe layers, and the thickness of the seed layer having a single-layer structure of NiFeCr and a rate (ΔR/R) of change in resistance;

FIG. 8 is a graph showing the relationship between the thickness of the seed layer in which a Co layer is formed below a NiFeCr layer, and the thickness of the seed layer having a single-layer structure of NiFeCr and a minimum resistance value; and

FIG. 9 is a graph showing the relationship between the thickness of the seed layer in which a Co layer is formed below a NiFeCr layer, and the thickness of the seed layer having a single-layer structure of NiFeCr and a rate (ΔR/R) of change in resistance.

### DETAILED DESCRIPTION OF THE PRESENTLY PREFERRED EMBODIMENTS

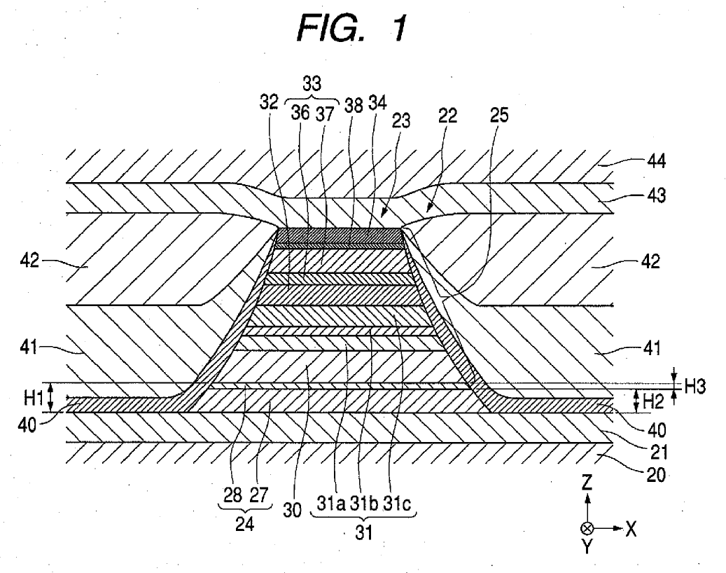

FIG. 1 is a cross sectional view (parallel to the surface of a recording medium) of a thin film magnetic head having a spin valve thin film element. The spin valve thin film element is provided at a trailing side end or the like of a floating slider, which is provided on a hard disk device, and detects a recording magnetic field such as from a hard disk.

The X direction corresponds to track width, the Y direction corresponds to the distance from the field, and the Z direction corresponds to the moving direction of the magnetic recording medium as well as the laminated direction of the spin valve thin film element. Each of the track width direction, the height direction, and the lengthwise direction is perpendicular to the remnant two directions. The surface facing the recording medium is the surface that is parallel to X-Z plane.

The thin film magnetic head has a lower shield layer 20 that may be a magnetic material such as a NiFe alloy.

A lower gap layer 21 is on the lower shield layer 20. The lower gap layer 21 may be an insulating material such as Al₂O₃, AlSiO, or SiO₂.

The spin valve thin film element 22 is on the lower gap layer 21. A laminated body 23 is formed at a center portion in the track width direction (X direction in FIG. 1) of the spin valve thin film element 22.

The laminated body 23 is configured so as to have a seed layer 24 and a magnetoresistance effect part 25. The seed layer 24 has a laminated structure in which a Co layer 28 is formed on a NiFeCr layer 27.

The magnetoresistance part 25 is formed with an antiferromagnetic layer 30, a fixed magnetic layer 31, a nonmagnetic material layer 32, a free layer 33, and a protective layer 34.

The antiferromagnetic layer 30 is formed of antiferromagnetic materials containing an element X (where, X is at least one element of Pt, Pd, Ir, Rh, Ru, or Os) and Mn. Alternatively, the antiferromagnetic layer 30 may be formed of antiferromagnetic materials containing the element X and X′ (where, X′ is at least one element of Ne, Ar, Kr, Xe, Be, B, C, N, Mg, Al, Si, P, Ti, V, Cr, Fe, Co, Ni, Cu, Zn, Ga, Ge, Zr, Nb, Mo, Ag, Cd, Sn, Hf, Ta, W, Re, Au, Pb, and a rare earth element) and Mn. For example, the antiferromagnetic layer 30 may be IrMn, PtMn, or the like.

In the embodiment shown in FIG. 1, the fixed magnetic layer 31 has a laminated ferri structure. The fixed magnetic layer 31 is laminated in the order of a first magnetic layer 31a, a nonmagnetic intermediate layer 31b, and a second magnetic layer 31c. Magnetizations of the first magnetic layer 31a and the second magnetic layer 31c are fixed so as to be anti-parallel to each other by an exchange coupling magnetic field at the interface with the antiferromagnetic layer 30 and an antiferromagnetic exchange coupling magnetic field (RKKY interaction) via the nonmagnetic intermediate layer 31b. For example, the first magnetic layer 31a and the second magnetic layer 31c may be a ferromagnetic material such as CoFe, NiFe, or CoFeNi. In addition, the nonmagnetic intermediate layer 31b is formed of nonmagnetic conductive materials such as Ru, Rh, Ir, Cr, Re, or Cu.

The nonmagnetic material layer 32 is formed of Cu, Au, and Ag.

The free magnetic layer 33 is formed of a soft magnetic layer 37 and a diffusion blocking layer 36 formed between the soft magnetic layer 37 and the nonmagnetic material layer 32. The soft magnetic layer 37 is formed of magnetic materials such as a NiFe alloy. The diffusion blocking layer 36 is formed of CoFe or the like. The free magnetic layer 33 may be formed so as to have the laminated ferri structure similar to the fixed magnetic layer 31. Alternatively, if the free magnetic layer 33 is formed so as to have the laminated structure of the magnetic material layer, the free magnetic layer 33 may be not only a two-layer structure but also a single-layer structure or a laminated structure of three or more layers.

A mirror reflection layer (specular layer) 38 is formed on the free magnetic layer 33. The mirror reflection layer 38 is formed, for example, of an oxide layer formed by an oxidation of the surface of the soft magnetic layer 37 configuring the free magnetic layer 33. The mirror reflection layer 38 may not be formed.

The protective layer 34 is formed of Ta or the like. The protective layer 34 is naturally oxidized to become Ta—O.

Both sides in the track width direction (X direction) of the laminated body 23 are formed by an inclined surface or a curved surface so that the width dimension in the track width direction of the laminated body 23 becomes gradually smaller from the bottom to the top. The cross section of the laminated body 23 is formed so as to have an approximate trapezoidal shape.

A bias underlayer 40 is formed from the top of the lower gap layer 21 to both sides of the laminated body 23. A hard bias layer 41 is formed on the bias underlayer 40. An electrode layer 42 is formed on the bias underlayer 41. The bias underlayer 40 is formed of Cr or the like. The hard bias layer 41 is formed of a CoPt alloy or CoCrPt alloy. The electrode layer 42 is formed of a conductive material such as Cr, W, Au, Rh, α-Ta, or the like.

An upper gap layer 43 is formed on the spin valve thin film element 22, and an upper shield layer 44 is formed on the upper gap layer 43. The upper gap layer is formed of an insulating material such as Al₂O₃ or SiO₂, and the upper shield layer 44 is formed of a magnetic material such as NiFe.

The free magnetic layer 33 is magnetized in the direction parallel to the track width direction by a bias magnetic field supplied from the hard bias layer 41. Because the first magnetic layer 31a and second magnetic layer 31c, which configure the fixed magnetic layer 31, are fixed so as to be anti-parallel to each other in the direction parallel to the height direction, the magnetizations of the free magnetic layer 33 and the second magnetic layer 31c are perpendicular to one another. The magnetization direction of the free magnetic layer varies by the external magnetic field. When the magnetization directions of the free magnetic layer 33 and the second magnetic layer 31c are parallel to each other, the resistance value of the laminated body 23 is minimal (min. Rs). In addition, when the magnetization directions of the free magnetic layer 33 and the second magnetic layer 31c are anti-parallel to each other, the resistance value of the laminated body 23 is the greatest.

The seed layer 24 is formed so as to have a two-layer structure in which a Co layer 28 is laminated on a NiFeCr layer 27. Both the NiFeCr layer 27 and the Co layer 28 have a face-centered cubic structure (fcc structure). Furthermore, the antiferromagnetic layer 30, which configures the magnetoresistance effect part 25, is directly formed on the seed layer 24.

If the seed layer 24 has the two-layer structure in which the Co layer 28 is laminated on the NiFeCr layer 27, the seed effect may be efficiently exhibited, and the high rate (ΔR/R) of change in resistance can be obtained, even if the thickness H1 of the seed layer 24 is thinly formed.

“Seed effect” means the improvement of crystalline, and in particular, means that the crystalline orientation in the direction (parallel to the X-Y plane) parallel to the surface of each layer of the magnetoresistance part 25 formed on the seed layer 24 is preferentially oriented to (111) plane.

It is possible to form such that the thickness H1 of the seed layer 24 according to the embodiment of the invention is smaller than that of the related art. In related art in which the seed layer 24 having the single-layer structure of NiFeCr is provided, if the thickness H1 of the seed layer 24 is less than 38 \acute{Å}, it has been known from the experiments described below that the seed effect is reduced, thus allowing the rate (ΔR/R) of change in resistance to largely reduce. The reason is why the thickness H2 of the NiFeCr layer 27 is thin and the (111) orientation of the NiFeCr layer 27 is insufficient to reduce the seed effect. On the other hand, in the present embodiment, even though the NiFeCr layer 27 is thin (H2) and has insufficient crystalline, a Co layer 28 (H3) is formed on the NiFeCr layer 27 such that the Co layer 28 is stably oriented to the (111) plane. Accordingly, atoms of the NiFeCr layer 27 are rearranged, and the (111) orientation of the NiFeCr layer 27 is sufficiently high. Both the NiFeCr layer 27 and the Co layer 28 have a face-centered cubic structure (fcc structure), and the (111) orientation of the closest packed plane is improved. Therefore, even when the seed layer 24 is thin, the seed effect is properly exhibited.

The thickness of the seed layer 24 (H1) is the sum of the thickness of the NiFeCr layer 27 H2 and the Co layer 28 (H3). Preferably, the thickness of the seed layer 24 (H1) be in a range of 28 to 38 \acute{Å}. If the thickness of the seed layer 24 (H1) is below 28 \acute{Å}, even though the thickness ratio of the Co layer 28 is varied, the rate (ΔR/R) of change in resistance may be effectively improved.

If the seed layer 24 is formed by the single structure of NiFeCr, if the thickness of the seed layer 24 (H1) is not more than 38 \acute{Å}, it may be impossible to heighten the rate (ΔR/R) of change in resistance (that is, in the related art, it is required that the thickness H1 of the seed layer 24 is formed in more than 38 \acute{Å}). However, in the present embodiment, even though the thickness of the seed layer 24 (H1) is 38 \acute{Å} or less, it is possible to obtain the stably high rate (ΔR/R) of change in resistance.

Preferably, the thickness of the Co layer 28 (H3) is within 2 to 8 \acute{Å}. For this reason, even though the thickness of the seed layer 24 (H1) within 28 to 38 \acute{Å}, it is possible to obtain the high rate (ΔR/R) of change in resistance. If the thickness of the Co layer 28 (H3) is at the high end of 2 to 8 \acute{Å}, and the thickness of the seed layer 24 (H1) is therefore lower, a relatively high rate (ΔR/R) of change in resistance is still obtained. However, the Co layer 28 has a low specific resistance as compared with the NiFeCr layer 27, the thickness ratio of the Co layer 28, which occupies the seed layer 24, is high, and the shunt current flowing to the Co layer 28 increases. Therefore, the influence of the shunt loss increases as compared with the seed effect. A peak value of the rate (ΔR/R) of change in resistance is a maximum, when the thickness H3 of the Co layer 28 is about 4 \acute{Å}. Meanwhile, if the thickness H3 of the Co layer 28 is 4 \acute{Å} or more, the peak value of the rate (ΔR/R) of change in resistance is gradually lowered. Accordingly, the thickness H3 of the Co layer 28 preferably is in a range of 4 to 6 \acute{Å}.

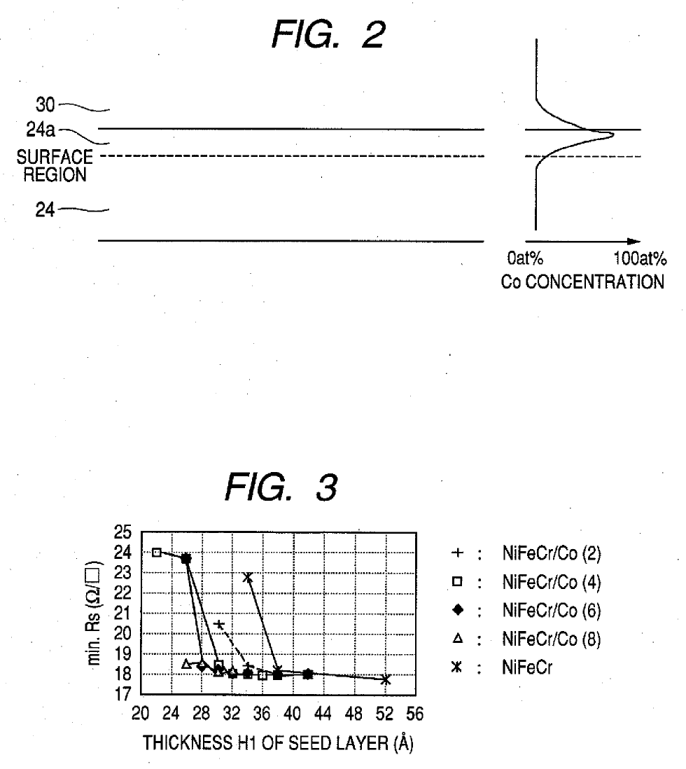

As described above, the Co layer 28 (H3) may be thin. The Co layer 28 can generate element diffusion between the NiFeCr layer 27 therebelow and the antiferromagnetic layer 30 by thermal influence. Accordingly, as shown in FIG. 2, the seed layer 24 is formed with NiFeCr as a main component, and Co concentration in a surface region 24a of the seed layer 24 may be higher than that in other regions of the seed layer. As shown in FIG. 2, a part of Co is diffused in the antiferromagnetic layer 30. Therefore, the antiferromagnetic layer 30 has the region in which Co concentration is gradually reduced from the lower surface to the upper surface.

It is preferable that the surface region 24a have the region in which Co concentration is 100%. For this reason, even though the region formed of NiFeCr is thinly formed, resulting in having the insufficient crystalline, the region having the extremely high Co concentration exists on NiFeCr. In addition, atoms of NiFeCr are rearranged, and the (111) orientation of the seed layer 24 is sufficiently high. Therefore, even when the thickness of the seed layer 24 is thinly formed, it is possible to properly exhibit the seed effect.

In composition analysis, for example, SIMS analysis equipment or Nano-beam EDX using field emission transmission electron microscope (FE-TEM) is used.

The NiFeCr layer 27 has composition formula as a follow. That is, the composition formula of the NiFeCr layer 27 is expressed by {NiₓFe₁₋ₓ}_{y}Cr_{100-y}. It is preferable that Ni ratio x be in a range of 0.7 to 1, and y be in a range of 56% to 76%. In addition, “Ni ratio x” is expressed by Ni %/(Ni %+Fe %). For example, the NiFeCr layer 27 is formed of {Ni_{0.8}Fe_{0.2}}_{60%}Cr_{40%}.

In the embodiment shown in FIG. 1, a CoFe layer (in this regard, composition ratio of Co is in a range of 90 to 100%) instead of the Co layer 28 may be formed on the NiFeCr layer. That is, the seed layer 24 is formed in two-layer structure of the NiFeCr layer 27 and the CoFe layer, and the antiferromagnetic layer 30 is directly formed on the CoFe layer.

If the Co composition ratio of the CoFe layer is smaller than 90%, a dependency of the rate (ΔR/R) of change in resistance relative to the seed thickness is approximately equal to that when the seed layer 24 is formed in the single-layer structure of NiFeCr. Therefore, it may be impossible to thinly maintain the thickness H1 of the seed layer 24 while holding the rate (ΔR/R) of change in resistance with a high value. Meanwhile, the Co composition ratio of the CoFe layer is set to 90% or more, there has been known by the experiments described below that it is possible to obtain the high rate (ΔR/R) of change in resistance relative to the seed thickness even though the seed layer 24 is thin.

When the seed layer 24 is formed in two-layer structure of the NiFeCr layer 27 and the CoFe layer, the thickness of the seed layer 24 is in a range of 28 to 38 \acute{Å}, and more preferably, in a range of 34 to 38 \acute{Å}. In the case of using a Co_{90%}Fe_{10%}, if the thickness of the seed layer 24 is smaller than 34 \acute{Å}, the rate (ΔR/R) of change in resistance is easily lowered. Therefore, it is preferable that the thickness of the seed layer 24 be 34 \acute{Å} or more. In addition, it is preferable to have the thickness of the CoFe layer and the Co layer 28 in the range of 2 to 8 \acute{Å}.

From the experiments described below, it is known that a seed layer 24 having the two-layer structure of the NiFeCr layer 27 and the Co layer 28 laminated on the NiFeCr layer 27 prefers to the seed layer 24 having the two-layer structure of the NiFeCr layer 27 and the Co layer 28 laminated on the NiFeCr layer 27. The reason is why the thickness range of the seed layer 24 capable of stably obtaining the high rate (ΔR/R) of change in resistance is widely varied.

In this embodiment, the seed layer 24 is formed in the two-layer structure of the NiFeCr layer 27 and the Co layer 28 laminated on the NiFeCr layer 27, the two-layer structure of the NiFeCr layer 27 and the CoFe layer (here, composition ratio of Co is in a range of 90% to 100%) laminated on the NiFeCr layer 27, or the NiFeCr layer as a main component. In addition, the seed layer 24 is formed such that the Co concentration in a surface region of the seed layer 24 is higher than that in other regions of the seed layer 24. Accordingly, even though the seed layer 24 is thin compared to the related art (in which the seed layer 24 is formed in the single-layer structure of the NiFeCr layer) the seed effect may be efficiently exhibited, and the high rate (ΔR/R) of change in resistance is obtained. In addition, in the case of CIP-GMR shown in FIG. 1, the shunt current flowing from the electrode layer 42 to the seed layer 24 is reduced by thinly forming the thickness of the seed layer 24, thus improving reproduction output. Furthermore, since the seed layer 24 is thin, the gap between the shield layers 20 and 44 becomes small. Therefore, it is possible to improve the line recording density.

Hereinafter, a method of manufacturing the spin valve thin film element will be described. After the lower gap layer 21 is formed on the lower shield layer 20, the seed layer 24 having the laminated structure of the NiFeCr layer 27 and the Co layer 28 is formed on the lower gap layer 21. The seed layer 24 is formed within the thickness range of 28 to 38 \acute{Å}, and the Co layer 28 is formed within the thickness range of 2 to 8 \acute{Å}. Then, the magnetoresistance part 25, which is provided with the antiferromagnetic layer 30, the fixed magnetic layer 31, the nonmagnetic material layer 32, the free magnetic layer 33, and the protective layer 34, is formed on the seed layer 24. After the laminated body 23 having the seed layer 24 and the magnetoresistance part 25 is manufactured so as to have the approximate trapezoidal shape as shown in FIG. 1, the bias underlayer 40, the hard bias layer 41, and the electrode layer 42 are laminated from the bottom on both sides in the track width direction (X direction in FIG. 1) of the laminated body 23.

The upper gap layer 43 is formed on the protective layer 34 and the electrode layer 42, and the upper shield layer 44 is formed on the upper gap layer 43.

In addition, the configuration of the seed layer 24 as shown in FIG. 1 may be applied to CPP (Current Perpendicular to the Plane)—GMR which flows the current from the direction perpendicular to the plane with respect to each layer of the laminated body 23. The laminated body 23 configures the spin valve thin film element.

In addition, for example, the magnetoresistance part 25 may be laminated in order of the free magnetic layer 33, the nonmagnetic material layer 32, the fixed magnetic layer 31, and the antiferromagnetic layer 30 from the bottom. However, as shown in FIG. 1, it is preferred to form the antiferromagnetic layer 30 below the free magnetic layer 33. For this reason, even though the thickness of the seed layer 24 is thinly formed, the seed effect may be efficiently exhibited, and the high rate (ΔR/R) of change in resistance can be obtained.

As shown in FIG. 1, the spin valve thin film element was formed. The laminated body, which configures the spin valve thin film element, was formed so as to have fundamental layers as follows. The fundamental layers were formed in order of (from bottom to top): substrate/seed layer; [{Ni_{0.8}Fe_{0.2}}_{50%}Cr_{40%}/Co]/antiferromagnetic layer; IrMn (55)/fixed magnetic layer [Fe_{30%}Co_{70%} (14)/Ru (8.7)/Co (22)]/nonmagnetic material layer; Cu (19)/free magnetic layer; [Co_{90%}Fe_{10%}/Co_{70%}Fe_{30%}/Ni_{80%}Fe_{20%}/Co_{90%}Fe_{10%}]/protective layer; Ta (16). The numeric values in parentheses indicate the preferred layer thickness (\acute{Å}).

In the experiments, the relationship between the thickness of the seed layer and the minimum resistance value (min. Rs) and the relationship between the thickness of the seed layer and the rate of change in resistance (ΔR/R) were examined by varying the thickness of the seed layer with the state in which the thickness of the Co layer configuring the seed layer was fixed to 2 \acute{Å}, 4 \acute{Å}, 6 \acute{Å}, or 8 \acute{Å}. In addition, the experiment was performed about the spin valve thin film element having the seed layer of the single-layer structure formed of NiFeCr.

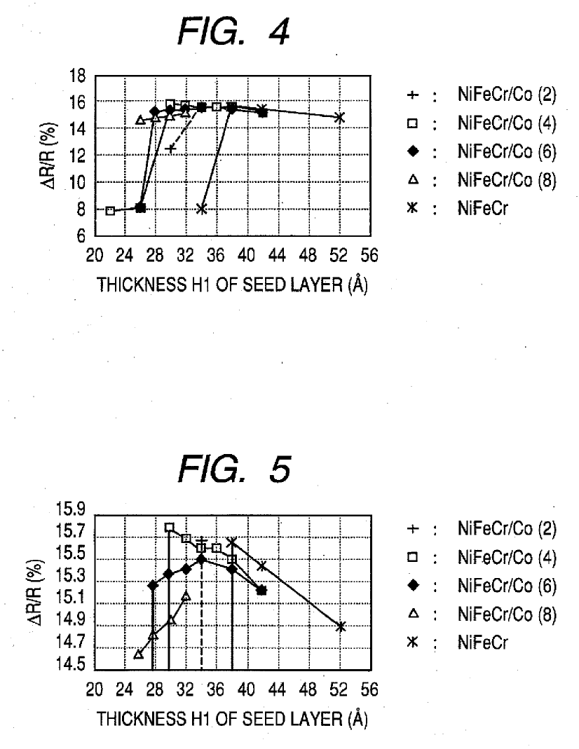

FIG. 3 is a graph showing the relationship between the thickness of the seed layer and the minimum resistance value (min. Rs), and FIG. 4 is a graph showing the relationship between the thickness of the seed layer and the rate (ΔR/R) of change in resistance.

As shown in FIG. 3, in the case of using the seed layer having the single-layer structure of NiFeCr, if the thickness of the seed layer is below about 38 \acute{Å}, it can be understood that the minimum resistance value (min. Rs) rapidly rises. The reason is why when the seed layer has the single-layer structure of NiFeCr, if the thickness of the seed layer is 38 \acute{Å} or less, the crystallized state of the seed layer is destabilized (the (111) plane is not most preferentially oriented in the direction of the surface), thus not improving the crystalline of the laminated body on the seed layer by the reduction of the seed effect.

Meanwhile, when the seed layer has the two-layer structure of the NiFeCr layer and the Co layer laminated on the NiFeCr layer, even if the thickness of the seed layer is 38 \acute{Å} or less, it can be found that the low stabilized minimum resistance value (min. Rs) is obtained. As shown in FIG. 3, as the thickness of the Co layer becomes thicker, even when the thickness of the seed layer becomes thinner, it is possible to obtain the low stabilized minimum resistance value (min. Rs).

As shown in FIG. 4, in the case of using the seed layer having the single-layer structure of NiFeCr, if the thickness of the seed layer is below about 38 \acute{Å}, it can be understood that the rate (ΔR/R) of change in resistance is rapidly reduced. The rapid reduction of the rate(ΔR/R) of change in resistance is caused by the fact that the minimum resistance value (min. Rs) shown in FIG. 3 rapidly increases, thereby R (denominator) of the rate (ΔR/R) of change in resistance increases.

When the seed layer has the two-layer structure of the NiFeCr layer and the Co layer laminated on the NiFeCr layer, even if the thickness of the seed layer is 38 \acute{Å} or less, it can be found that the high stabilized rate (ΔR/R) of change in resistance is obtained.

FIG. 5 is a graph enlarged in a range of 14.5 to 15.9 (%) of the rate of change in resistance, which is indicated by a vertical axis of FIG. 4. As shown in FIG. 5, in the case of using the seed layer having the single-layer structure of NiFeCr, if the thickness of the seed layer is about 38 \acute{Å}, the rate (ΔR/R) of change in resistance becomes a peak value. Furthermore, in this case, if the thickness of the seed layer is about 38 \acute{Å} or less, it can be understood that the rate (ΔR/R) of change in resistance is rapidly reduced.

If the thickness of the Co layer is 2 \acute{Å} and the thickness of the seed layer is in a range of 34 to 38 \acute{Å}, a high stabilized rate (ΔR/R) of change in resistance is obtained. If the thickness of the Co layer is 4 \acute{Å} and the thickness of the seed layer is in a range of 30 to 38 \acute{Å}, a high stabilized rate (ΔR/R) of change in resistance is obtained. If the thickness of the Co layer is 6 \acute{Å} and the thickness of the seed layer is in a range of 28 to 38 \acute{Å}, a high stabilized rate (ΔR/R) of change in resistance can be obtained. If the thickness of the Co layer is 8 \acute{Å} and the thickness of the seed layer is in a range of 28 to 32 \acute{Å}, a high stabilized rate (ΔR/R) of change in resistance is obtained.

From the experimental results, the thickness of the seed layer is set in a range of 28 to 38 \acute{Å}, or more, and the thickness of the Co layer is set in a range of 2 to 8 \acute{Å}. In addition, if the thickness of the Co layer is 2 \acute{Å} and the thickness H1 of the seed layer is smaller than 34 \acute{Å}, the rate (ΔR/R) of change in resistance is significantly reduced. Therefore, it is preferable that the thickness of the Co layer is in a range of 4 to 8 \acute{Å}. In addition, if the thickness of the Co layer is 8 \acute{Å}, even though the thickness of the seed layer is smaller than 28 \acute{Å}, it is possible to obtain the high rate (ΔR/R) of change in resistance as compared with other specimens in which the thickness of the Co layer is small. However, in the case that the thickness of the seed layer is in a range of 28 to 38 \acute{Å}, as the thickness of the Co layer becomes smaller, the high rate (ΔR/R) of change in resistance may be obtained. That is, for example, when the thickness of the seed layer is 32 \acute{Å}, as the thickness of the Co layer becomes smaller like 8 \acute{Å}, 6 \acute{Å}, and 4 \acute{Å}, it can be found that the rate (ΔR/R) of change in resistance becomes higher. The change to the higher value of the rate(ΔR/R) in resistance is caused by the fact that the specific resistance of the Co layer is lower than that of the NiFeCr layer. And when the increase of the ratio of the thickness of the Co layer to the thickness of the seed layer is taken into account, the fact leads to the larger shunt loss of a sense current flowing to the seed layer. Therefore, it is considered that the rate (ΔR/R) of change in resistance is reduced. Accordingly, it is preferable that the thickness of the Co layer is set in a range of 4 to 6 \acute{Å}.

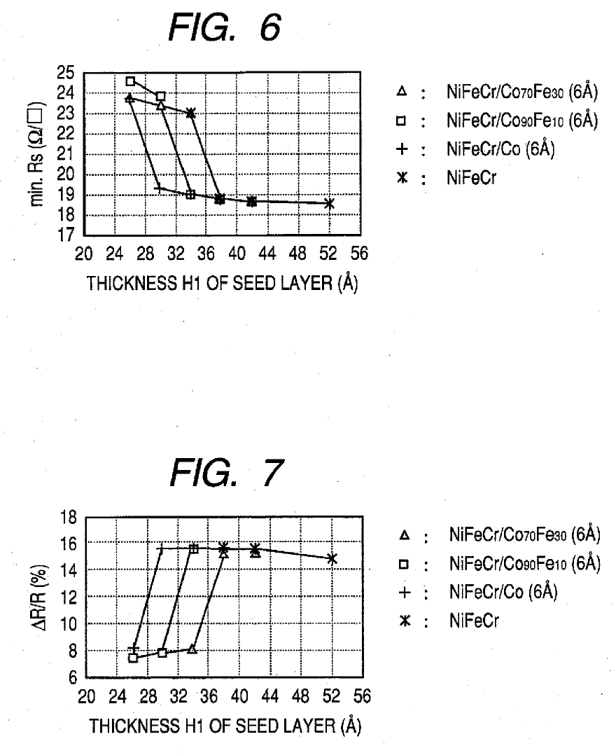

Next, by each preparing the spin valve thin film element in which the thickness of the Co layer among the fundamental layers is 6 \acute{Å}, the spin valve thin film element using Co_{70%}Fe_{30%} layer (the thickness thereof is 6 \acute{Å}) instead of the Co layer, the spin valve thin film element using Co_{90%}Fe_{10%} layer (the thickness thereof is 6 \acute{Å}) instead of the Co layer, and the spin valve thin film element in which the seed layer is formed in the single-layer structure of NiFeCr, the relationship between the thickness H1 of the seed layer and the minimum resistance value (min. Rs) and the relationship between the thickness of the seed layer and the rate (ΔR/R) of change in resistance are measured. The results are shown in FIGS. 6 and 7.

As shown in FIG. 6, the dependency of the minimum resistance value (min. Rs) relative to the thickness of the seed layer having the single-layer structure of NiFeCr is approximately equal to that of the minimum resistance value (min. Rs) relative to the thickness of the seed layer having the two-layer structure of NiFeCr and Co_{70%}Fe_{30%}.

Meanwhile, if the seed layer has the two-layer structure of NiFeCr and Co_{90%}Fe_{10%} and has the two-layer structure of NiFeCr and Co, even though the thickness of the seed layer is set to 38 \acute{Å} or less, it can be found that the low stabilized minimum resistance value (min. Rs) is obtained.

In addition, as shown in FIG. 7, the dependency of the rate (ΔR/R) of change in resistance relative to the thickness of the seed layer having the single-layer structure of NiFeCr is approximately equal to that of the rate (ΔR/R) of change in resistance relative to the thickness of the seed layer having the two-layer structure of NiFeCr and Co_{70%}Fe_{30%}.

Meanwhile, if the seed layer has the two-layer structure of NiFeCr and Co_{90%}Fe_{10%} and has the two-layer structure of NiFeCr and Co, even though the thickness of the seed layer is set to 38 \acute{Å} or less, it can be found that the high stabilized rate (ΔR/R) of change in resistance is obtained.

From the experimental results shown in FIGS. 6 and 7, when the seed layer is formed in the two-layer structure in which CoFe is laminated on NiFeCr, the composition ratio of Co which occupies CoFe is set to be in a range of 90% to 100%.

In the above, in the case that the seed layer is formed so as to have the laminated structure of NiFeCr and Co, NiFeCr is necessarily formed below Co. However, conversely, that is, in the case that the seed layer has the structure in which NiFeCr is formed on Co, the dependency of the minimum resistance value (min. Rs) relative to the thickness of the seed layer and the dependency of the rate (ΔR/R) of change in resistance relative to the thickness of the seed layer were measured.

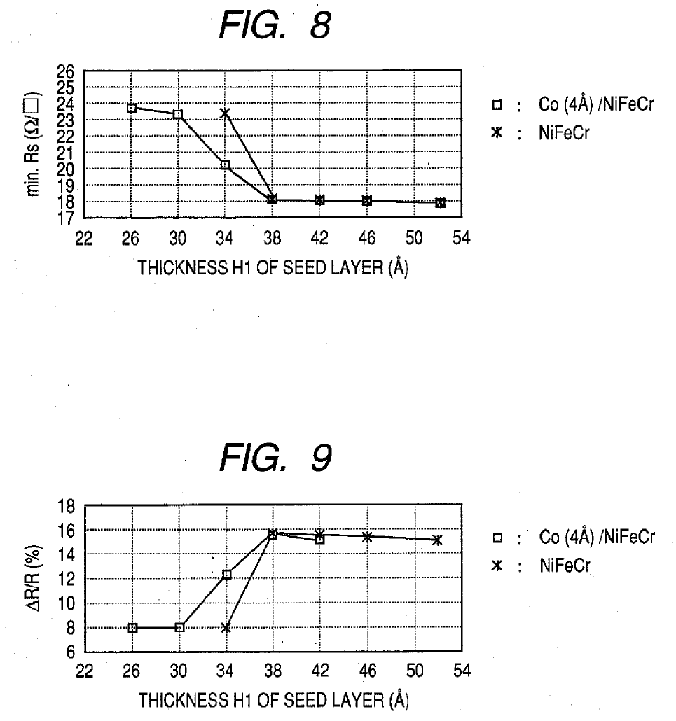

In the experiment, the thickness of the Co layer was fixed to 4 \acute{Å}, and the dependency relative to the thickness of the seed layer having the laminated structure of Co/NiFeCr and the dependency relative to the thickness of the seed layer having the single-layer structure of NiFeCr were measured. The experimental results were shown in FIGS. 8 and 9.

As shown in FIGS. 8 and 9, in the seed layer having the laminated structure of Co/NiFeCr and the seed layer having the single-layer structure of NiFeCr, if the thickness of the seed layer was 38 \acute{Å} or less the minimum resistance value (min. Rs) drastically rises and the rate (ΔR/R) of change in resistance was reduced. In the case of forming the seed layer having the laminated structure of Co/NiFeCr, if the thickness of the seed layer became thinner, it is possible to obtain the significant rate (ΔR/R) of change in resistance.

Accordingly, in the case of forming in the laminated structure of the seed layer/NiFeCr/Co, if NiFeCr is formed below Co, even if the thickness of the seed layer is thinly formed, it can be found that the largely stabilized rate (ΔR/R) of change in resistance is preferably obtained.

While various embodiments of the invention have been described, it will be apparent to those of ordinary skill in the art that many more embodiments and implementations are possible within the scope of the invention.

Accordingly, the invention is not to be restricted except in light of the attached claims and their equivalents.

It is intended that the foregoing detailed description be understood as an illustration of selected forms that the invention can take and not as a definition of the invention. It is only the following claims, including all equivalents, that are intended to define the scope of this invention.

1. A magnetic detecting device comprising:
a fixed magnetic layer;
a free magnetic layer, the magnetization direction of the fixed magnetic layer being oriented in a predetermined direction, the magnetization of the free magnetic layer being varied by an external magnetic fields, and the free magnetic layer facing the fixed magnetic layer;
a nonmagnetic material layer between the fixed magnetic layer and the free magnetic layer; and
a laminated seed layer having NiFeCr and proximate the fixed magnetic layer.

2. The apparatus of claim 1 wherein the laminated seed layer comprises a Co layer.

3. The apparatus of claim 1 wherein the laminated seed layer comprises a CoFe layer having a composition ratio of approximately 90% to 100%.

4. The apparatus of claim 1 wherein the laminated seed layer has a thickness in the range of 28 to 38 \acute{Å}.

5. The apparatus of claim 4 wherein the laminated seed layer comprises a CoFe layer having a composition ratio of approximately 90% to 100% and a thickness in the range of 2 to 8 \acute{Å}.

6. A magnetic detecting device comprising:
a magnetoresistance effect part that includes a fixed magnetic layer and a free magnetic layer, the magnetization direction of the fixed magnetic layer being oriented in a predetermined direction, the magnetization of the free magnetic layer being varied by an external magnetic field, and the free magnetic layer facing the fixed magnetic layer with a nonmagnetic material layer interposed therebetween; and
a seed layer that is provided below the magnetoresistance effect part, wherein the laminated seed layer comprises Co concentrated in a surface region of the seed layer.

7. The apparatus of claim 6 wherein a portion of the surface region is 100% Co.

8. The apparatus of claim 6 wherein the laminated seed layer has a thickness in the range of 28 to 38 \acute{Å}.

9. The apparatus of claim 1 further comprising:
an antiferromagnetic layer in contact with the fixed magnetic layer and the laminated seed layer; and
wherein the fixed magnetic layer, the free magnetic layer, and the nonmagnetic material layer are laminated on the antiferromagnetic layer.

10. The apparatus of claim 1 further comprising:
a bias magnetic field in communication with the free magnetic layer.

11. The apparatus of claim 10 wherein the bias magnetic field is generated by a bias layer and an electrode layer, the bias layer and the electrode layer laminated in a track width direction.
